(19) United States
(12) Patent Application Publication
(10) Pub. No.: US 2002/0032633 A1
(43) Pub. Date: Mar. 14, 2002

(54) ELECTRONIC BUYER-SELLER INTERMEDIATION SERVICE AND PRICE DETERMINATION

(76) Inventor: Hirotane Okumura, Kawasaki (JP)

Correspondence Address: STAAS& halsey, Suite 500, 700 Eleventh Street, N.W., Washington, DC, 20001, US

(21) Appl. No.: 09/739,759

(22) Filed: Dec. 20, 2000

(30) Foreign Application Priority Data
Jul. 25, 2000 (JP) 2000-224359

(51) Int. Cl. G06F 17/60

(52) U.S. Cl. 705/37

(57) ABSTRACT

Sale and purchase offers entered through client machines 22 and 23 are written in records into a memory of a transaction intermediary server 21. Sale and purchase offers matching in transaction conditions are retrieved from a plurality of sale and purchase offers stored in the memory. The intermediary, selling and buying prices of a commodity to be sold and bought are determined from the lowest allowable selling price and the highest allowable buying price presented by the seller and the buyer. A description of the commodity and the buying price are written into the record of the retrieved purchase offer. The buyer can access his or her own purchase offer record and the seller can access his or her own sale offer record.

### FIELD OF THE INVENTION

This invention relates to an electronic intermediation service for buyers and sellers of commodities through networks, such as the Internet, and also to commodity price determination in such electronic commerce.

### BACKGROUND OF THE INVENTION

When one is going to move, he or she usually has to dispose of unnecessary things. There are many other cases such things a person thinks unnecessary. He or she may want to sell the unnecessary things or used things. In such a case, he or she may put up posters on, for example, campus bulletin boards, bring them to a garage sale, or individually bargain.

The prices of goods are set by a seller, and a buyer decides whether he or she accepts the price. Frequently, sellers present prices of particular goods, spending time and effort to explain how the presented prices are reasonable. Such explanations are also given to people having no intention to buy goods, so that who want to sell what goods are known to such people. Such information should be kept unknown, if possible.

Although there are many possible sellers and buyers, there are few chances for those people to negotiate. If such opportunity is given in the form of non-electronic or conventional market, such commerce may not pay to any of sellers, buyers or intermediaries. As a result, too much time is wasted for selling and buying low price goods, used goods are not re-cycled, or goods are sold at unreasonably low prices. Sometimes, people unnecessarily have to buy new goods.

In known Internet auctions, sellers offer goods for sale on the Internet, and buyers offer some prices for the goods before a time limit set by the sellers. The goods are sold to buyers who priced the goods highest above the lowest allowable price the sellers set. Possible buyers must access frequently to find whether or not goods they want to get are at auction, and carefully consider the sales offers. If one buyer offers a highest price for some goods early, both the buyer and the seller must wait to actually buy and sell the goods until the end of the time period the buyer has set. It may sometimes occur that a buyer who bought an item feels unsatisfactory for the price later.

In his U.S. Pat. No. 5,794,207, Jay S. Walker discloses reverse auctions as electronic commerce. According to Walker, buyers unilaterally set prices for goods through conditional purchase offer. Potential sellers receiving a number of such offers must study them one by one even if they think that reaching purchase agreement may be least likely. Sometimes, sellers may present counteroffer. In such a case, reaching agreement on prices between sellers and buyers should follow a complicated process.

A major object of the present invention is to provide potential buyers and sellers with opportunities for making purchase and sale offers and for making transactions between them. Another object of the present invention is to provide buyer-seller mediating services with proper benefits to both the buyer s and sellers.

### SUMMARY OF THE INVENTION

According to one aspect of the present invention, a transaction intermediary apparatus or a apparatus for mediating buyers and sellers includes a memory device, and writing means. The writing means is responsive to entry by a potential seller through an information processing apparatus for writing a sale offer in a form of a record into the memory device. The sale offer includes a description of a commodity the seller wants to sell and a minimum price for the commodity set by the seller. The writing means is also responsive to entry by a potential buyer through an information processing apparatus for writing a purchase offer in a form of a record into the memory device. The purchase offer includes a description of a commodity the buyer wants to buy and a maximum price for the commodity set by the seller. The apparatus further includes extracting means for searching a plurality of sale and purchase offers stored in the memory device for extracting a sale offer and a purchase offer which match in terms of commodity and price conditions, and for determining a selling price to be presented to the seller and a buying price to be presented to the buyer, of a commodity of the extracted sale offer, based on the minimum price in the extracted sale offer and the maximum price in the extracted purchase offer. The determined selling price is equal to or lower than the determined buying price. The extracting means writes the description of the commodity included in the extracted sale offer and the determined buying price, into the record of the extracted purchase offer in the memory device.

According to another aspect of the present invention, a transaction intermediary apparatus includes a memory device, and reception means which is responsive to entry by a potential seller through an information processing apparatus for writing a sale offer in a form of a record into the memory means, and for writing a sale status in the record of the sale offer. The sale offer includes a description of a commodity the seller wants to sell and a minimum price for the commodity set by the seller. The reception means is also responsive to entry by a potential buyer through an information processing means for writing a purchase offer in a form of a record in the memory device, and for writing a purchase status in the record of the purchase offer. The purchase offer includes a description of a commodity the buyer wants to purchase and a maximum price for the commodity set by the buyer. The intermediary apparatus further includes extracting means for searching a plurality of sale and purchase offers stored in the memory device for extracting a sale offer and a purchase offer which match in terms of commodity and price conditions, and for determining a selling price and a buying price of a commodity of the extracted sale offer based on the minimum price in the extracted sale offer and the maximum price in the extracted purchase offer. The determined selling price is equal to or lower than the determined buying price. The extracting means writes the description of the commodity included in the extracted sale offer and the determined buying price, in the record of the extracted purchase offer in the memory device, and also modifies the purchase status in the record of the extracted purchase offer. The intermediary apparatus also includes respondent means responsive to a buyer's request made through the information processing apparatus for providing the content of the record of the buyer's purchase offer to the information processing apparatus.

According to still another aspect of the present invention, a transaction intermediary program for use in an information processing apparatus stored in a recording medium causes a processor to perform the steps of: responding to entry by a potential seller for writing in a memory device, a record of a sale offer including a description of a commodity the seller wants to sell and a minimum price for the commodity set by the seller; responding to entry by a potential buyer for writing in the memory, a record of a purchase offer including a description of a commodity the buyer wants to buy and a maximum price for the commodity set by the buyer; searching a plurality of sale and purchase offers stored in the memory device for extracting a sale offer and a purchase offer which match in terms of commodity and price conditions; and determining selling and buying prices of the commodity in the extracted sale offer, based on the minimum price set by the seller in the extracted sale offer and the maximum price set by the buyer in the extracted purchase offer. The determined selling price is equal to or lower than the determined buying price. The program causes the processor a further step of writing the description of the commodity in the extracted sale offer and the determined buying price in the record of the extracted purchase offer in the memory device.

According to a further aspect of the present invention, a transaction intermediary program for use in an information processing apparatus stored in a recording medium causes a processor to perform the steps of: responding to entry by a potential seller for writing into a memory device, a record of a sale offer including a description of a commodity the seller wants to sell and a minimum price for the commodity set by the seller and writing a sale status in the record of the sale offer; responding to entry by a potential buyer for writing into the memory, a record of a purchase offer including a description of a commodity the buyer wants to buy and a maximum price for the commodity set by the buyer and writing a purchase status in the record of the purchase offer; searching a plurality of sale and purchase offers stored in the memory device for extracting a sale offer and a purchase offer which match in terms of commodity and price conditions; and determining selling and buying prices of the commodity in the extracted sale offer, based on the minimum selling price set by the seller in the extracted sale offer and the maximum buying price set by the buyer in the extracted purchase offer. The determined selling price is equal to or lower than the determined buying price. The program causes the processor further steps of: writing the description of the commodity in the extracted sale offer and the determined buying price into the record of extracted purchase offer in the memory device and modifying the purchase status of the record of the extracted purchase offer; and responding to a buyer's request for providing the content of the record of the buyer's purchase offer to the buyer.

According to a still further aspect of the invention, in a method for determining a price for a commodity or service in a transaction intermediary system, suggested conditions for transactions are received from potential buyers and sellers, the transactions are mediated, sellers and buyers present their ranges of acceptable prices for a commodity or service of interest, and a potential seller and a potential buyer who present ranges of acceptable prices which completely match or overlap each other are retrieved. A selling price and a buying price, which is higher than the selling price, are determined within the matching ranges of acceptable prices or within an overlapping portion of the acceptable price ranges. The determined selling price is presented to the retrieved seller, and the determined buying price is presented to the retrieved buyer.

According to the present invention, while protecting both the seller's privacy and the buyer's privacy, the buyers and sellers can present their purchase and sale offers and buy and sell commodities or services of interest in a simple way, and, still, they can obtain proper profits within the price ranges they present.

### BRIEF DESCRIPTION OF THE DRAWINGS

FIG. 1 shows a configuration of a system for realizing intermediary service and price determination in electronic commerce according to the present invention, which can be realized either by hardware or by software.

FIG. 2 is a general representation of procedures followed in a transaction intermediary system according to the present invention.

FIG. 3 is a transition diagram of operations in various functions of the intermediary system according to the present invention.

FIG. 4 shows a display screen for selecting transaction intermediary functions caused to be displayed on a screen of a client machine by a transaction intermediary server according to the present invention.

FIG. 5 is a flow chart of a member registration function of the transaction intermediary server according to the present invention.

FIG. 6A is a flow chart of a sale offer function of the transaction intermediary server according to the present invention,

FIG. 6B is a flow chart of a purchase offer function of the transaction intermediary server, and

FIG. 6C is a flow chart of a transaction canceling function of the transaction intermediary server.

FIG. 7A shows a flow chart of a member box reviewing function of the transaction intermediary server of the present invention, and

FIG. 7B shows a display screen of a member box displayed on a client machine by the transaction intermediary server.

FIG. 8 is a flow chart of buyer extraction, buying and selling price determination, and notifying function of the transaction intermediary server of the present invention.

FIG. 9 is a flow chart of a transaction settlement and notifying function of the transaction intermediary server of the present invention.

FIG. 10 is a flow chart of an account settlement function and a delivery function of the transaction intermediary server of the present invention.

### PREFERRED EMBODIMENT OF THE INVENTION

System Configuration

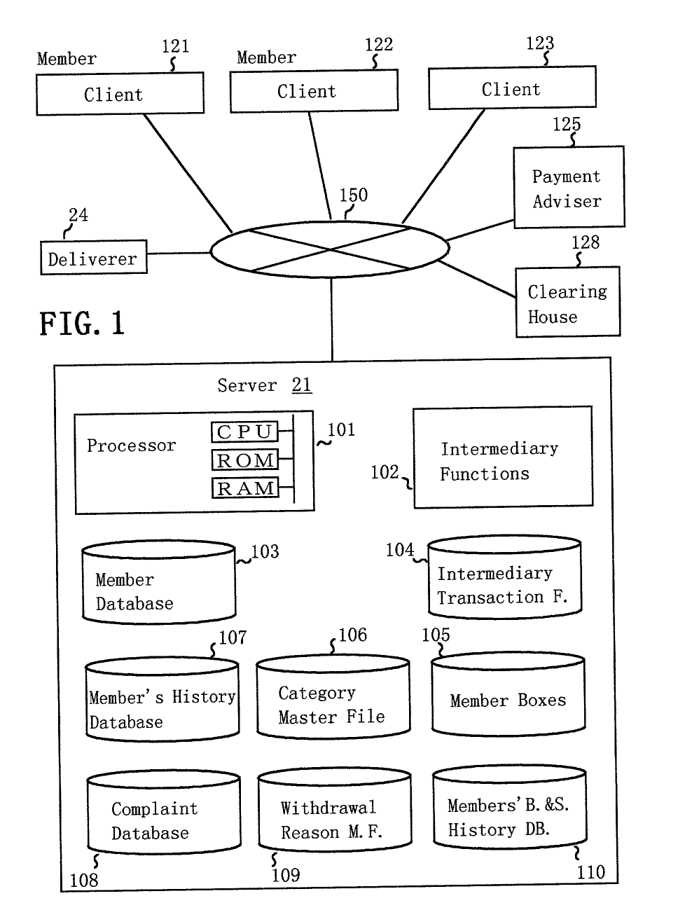

FIG. 1 shows a configuration of a system for intermediary service and price determination in electronic commerce according to the present invention. This system can be utilized only by people or organizations who have registered as a member of the intermediary system.

An intermediary server machine (also referred to simply as server hereinafter) 21 and a plurality of individual client machines (also referred to simply as a client or clients hereinafter) 121, 122 and 123 are interconnected by networks 150, which are typically the Internet, telephone lines and LAN. The server 21 is also connected to a machine advising of payment into a bank account in response to an inquiry (hereinafter referred to as payment advising machine) 125, a clearing house 128 which confirms the validity of credit cards, and a delivery company (deliverer) 24.

Configuration of Individual Client Machines

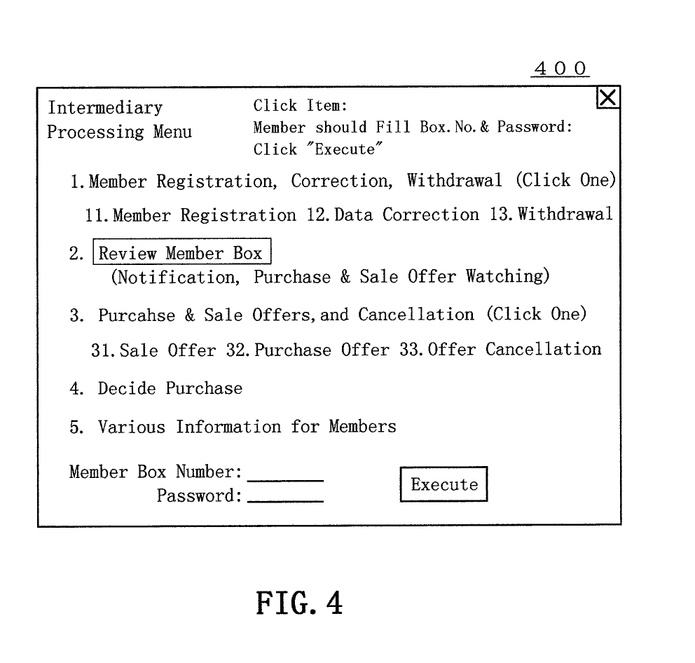

Each of the client machines 121, 122 and 123 is typically connected to the Internet via a telephone line and may be an ordinary personal computer with a processor, a memory, a modem, an interface, a video monitor, a keyboard and the like. An individual who has not yet registered himself or herself as a member can access the transaction intermediary server machine 21 through the client machine 123, and can be registered as a member by taking a necessary procedure through a “Member Registration” function activated through a Transaction Intermediary Processing Menu screen (a screen for selecting functions) 400 shown in FIG. 4. A member can access the server machine 21 through the client machine 121 or 122 and select desired ones of various functions described later on the display screen 400 (FIG. 4) for execution by the client machine.

Configuration of Transaction Intermediary Server

Referring to FIG. 1, the system configuration of the server machine 21 is described. Typically, the server machine 100 includes a processor 101, a memory, e.g. a magnetic disc, a network interface, a video monitor and a keyboard. Typically, the processor 101 includes a CPU, a ROM and a RAM. The server machine 21 also has a plurality of intermediary functions (i.e. a member management function, a transaction function and a data management function) implemented by application programs stored in a memory device 102, a plurality of databases, including a member database 103, a member's history database 107, a complaint database 108 and a member's buying and selling history database 110, a commodity category master file 106, a withdrawal reason master file 109, a sale-offer based intermediary transaction file 104 inaccessible to the members, a group of member boxes 105 accessible to the members, and a memory device (not shown) storing an OS. The server 21 has a member record stored in each member box 105, which member record includes a current status of sale and/or purchase offers and commodity information fields. Each member can access only his or her own member box in the server 21 through a client to know the current status of his or her sale and/or purchase offers.

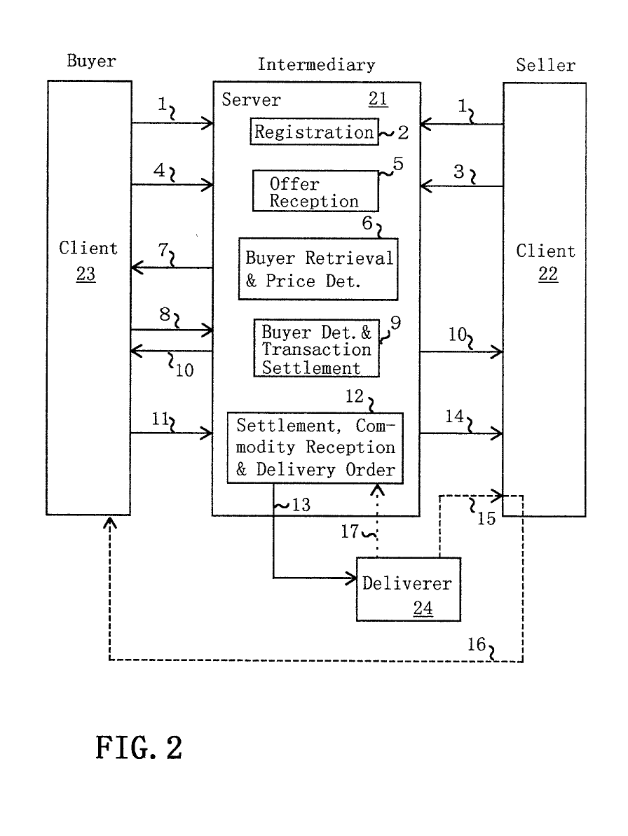

Now, referring to FIG. 2, a transaction intermediary procedure followed by the server 21 is briefly described.

First, an individual who has not become a member accesses the intermediary server 21 through either a client machine 22 or 23 as represented by a step (arrow) 1 and activates a member registration function 2 to register himself or herself as a member.

Next, a seller member accesses the server 21 through the client 22, as indicated by a step 3 to activate a purchase/sale offer reception function 5 and enters required data for a sale offer. The sale offer data is stored in a record in a sale offer list within a member box 105 for the client 22 in FIG. 1 in the server 21, and part of the data is stored in a record in the sale-offer based intermediary transaction file 104.

A buyer member accesses the server 21 through the client 23, as indicated by a step 4, to activate the purchase/sale offer reception function 5 and enters required data for a purchase offer. The purchase offer data is stored in a record in a purchase offer list within the member box 105 for the client machine 23 in the server 21. The reception of sale offers and the reception of purchase offers can be done independently at any times in the server 21.

In a step 6, the server 21 periodically, for example, at intervals of five minutes, retrieves from the intermediary transaction file 104, intermediary transaction records of unsettled offers in chronological order, and retrieves unsettled purchase offer records in the member boxes 105. Then, the server 21, looking into the sale offer record in the member box 105 corresponding to each of the retrieved unsettled offer transaction records, retrieves, as a candidate, one of the retrieved unsettled purchase offer records containing a commodity category and a transaction condition (price) which match those stored in that unsettled sale offer record. After that, the server 21 determines an intermediary price and selling and buying prices taking a commission into account. A plurality of purchase offers (i.e. candidate purchase offers) may be retrieved for one sale offer. In such a case, an intermediary price and selling and buying prices are determined for each of such candidate buyers or purchase offers.

In a step 7, the server 21 notifies a candidate buyer, via his or her member box 105, of the description of the candidate sale offer commodity and its determined buying price for that candidate buyer.

In a step 8, the candidate buyer accesses the server 21 to activate a buyer determination and transaction settling function 9, and can decide the purchase of the candidate commodity, using a purchase determination screen on the client screen displaying the description and buying price of the commodity. The server 21 determines the candidate buyer who decides first the purchase of the commodity, as the ultimate buyer.

In a step 10, the server 21 notifies through the member box 105, the member seller who offered the sale of the candidate commodity, of the settlement of the transaction and the determined selling price, and also notifies the buyer through his or her member box 105 of the settlement of the transaction regarding the commodity. At the same time, if there have been plural candidate buyers, the server 21 notifies the remaining candidate buyers through their member boxes, that they have failed in purchase.

The seller is notified of only the selling price the server 21 determines, but not of other selling prices determined for other candidate buyers or the determined buying prices. Also, the buyer is notified of only the buying price determined by the server 21 for him or her, but not of other buying prices determined for other candidate buyers or the determined selling prices.

Next, in a step 11, the successful buyer pays the buying price into the bank account of the intermediary associated with the server 21. The payment may be effected through the purchase determination screen in the step 8. Alternatively, the buyer may pay the money by his or her credit card, using the purchase determination screen used when he or she decides the purchase, or may access the server 21 anew for the payment by the credit card through the purchase determination screen.

After seeing that the payment has been actually made, using an account settlement function 12, the server 21 orders, in a step 13, the deliverer 24 to receive the commodity (a step 15) from the seller and to deliver the commodity (a step 16) to the buyer. Thereafter, the server 21 pays the money corresponding to the determined selling price into the seller's bank account in a step 14. The deliverer 24 sends a notification in a predetermined format by electronic mail to the server 21 to notify the reception and delivery of the commodity. The server 21 may make the payment into the seller's bank account only after receiving the notification of the reception of the commodity.

The notification to the members of matters relating to purchase and sale offers are done by the server 21 writing appropriate data in the sale or purchase offer records of the respective members through the member boxes 105 and by the respective members accessing and seeing their own member boxes. The server 21 may additionally send electronic mails to the members.

In the above description, what are sold and bought are described as being commodities, but they may be services.

Databases, Master Files, Files and Boxes

Now, the data structures of the databases, the master files, the files and the boxes constructed in the intermediary server 21 are described.

Member Database

The member database 103 shown in FIG. 1 includes currently valid data relating to the member box numbers, names, telephone numbers, addresses, the electronic mail addresses, the accounts (the bank accounts or the like) of the respective members, reasons for withdrawal from the intermediary system, a commission factor (or discount rate) and the last transaction date. The term “commission factor” used herein is intended for a factor by which the commission is multiplied, which is, for example, 0.9 for 10% of the members who have used more money through the system. In other words, the discount rate of 10% is applied to the commission for these members.

Member Boxes

A separate member box 105 is allotted to each member. Each member box 105 is assigned with its own member box number and stores sale and purchase offer records of data of the associated member which the member can access through a client machine. The sale and purchase offer records are as shown in TABLE I.

TABLE I
Member Box, Safe and Purchase Offer Lists

Member Box Number:
Safe Offer List (The number of offers is indicated here.)
-Sale Offer Number:
Sale Offer Date:
Sale/Purchase: Sale
Sale Status:
Commodity Category:
Commodity Name:
Time Limit for Settling Transaction:
Desired Lowest Selling Price SP min:
Description of Commodity:
Determined Buyer's Purchase Offer Number:
Determined Selling Price SPdet:
[-Sale Offer Number:]
. . .
Purchase Offer List (The number of offers is indicated here.)
-Purchase Offer Number:
Offer Date:
Sale/Purchase: Purchase
Purchase Status:
Commodity Category:
Time Limit for Settling Transaction:
Desired Highest Buying Price BPmax:
-Candidate Sale Offer Number:
Purchase Settlement Status:
Buying Price:
Commodity Name:
Description of Commodity:
[-Candidate Sale Offer Number:]
. . .
[-Purchase Offer Number:]
. . .

The sale offer list or record block in each member box includes fields in each sale offer record. The fields are for a sale offer number, a sale offer date, an indication of sale or purchase (“Sale” for a sale offer list), a sale status (i.e. “No Buyer”, “There Is a Candidate Buyer”, “Transaction Settled”, “Paid” and/or “Commodity Received”), a commodity category, a commodity name, a time limit for settling the transaction, a lowest allowable selling price SPmin set by a seller, a description of the commodity (a time period the commodity has been used, a model number, a digital photograph of the commodity), a determined buyer's purchase offer number, and a determined selling price SPdet which is indicated when “Transaction Settled” is indicated in the sale status field.

The purchase offer list (record block) in each member box includes various fields in each purchase offer record. The fields are for a purchase offer number, a purchase offer date, an indication of sale or purchase (“Purchase” for a purchase offer list), a purchase status (i.e. “No Seller”, “Candidate Buyer”, “Transaction Settled”, “Purchase Failed”, “Paid”, and/or “Commodity Delivered”), a commodity category, a commodity name, a time limit for settling the transaction, and a highest allowable buying price BPmax set by a buyer.

Each purchase offer record further includes at least one field for a candidate sale offer number and fields associated with each candidate sale offer number for a purchase settlement status (i.e. “Purchase Undecided”, “Purchase Decided” or “Purchase Failed”), a buying price, a commodity name, and detailed information about the commodity. The fields for a candidate sale offer number and its associated items are filled when the purchase status field is filled with an indication of “Candidate Buyer” or “Transaction Settled”, and otherwise are left blank. If there are more than one candidate sale offers, another set of similar fields will be displayed.

Each member can access his or her own member box only to know the contents of the sale or purchase offer and the current status. The server 21 may be arranged to notify associated members by electronic mail each time the contents of the statuses in each member box have been changed.

Sale-offer-based Intermediary Transaction File

The sale-offer-based intermediary transaction file 104 shown in FIG. 1 contains intermediary transaction records, each including basic data of each sale offer, based on which purchase offer records containing transaction conditions matching those of that sale offer are retrieved from the member boxes. As shown in TABLE II, each of the intermediary transaction records includes fields for: a sale offer number in the member box, the member box number of the member offering the sale, the sale status (i.e. “No Seller”, “Candidate Buyer”, “Transaction Settled”, “Purchase Failed”, “Paid”, and/or “Commodity Delivered”), and the last purchase offer number checked in the last member box search.

TABLE II
Intermediary Transaction File

Intermediary Transaction 1
-Sale Offer Number:
Seller Member Box Number:
Sale Status:
Last Purchase Offer Number Checked:
-Candidate Purchase Offer Number:
Candidate Buyer Member Box Number:
Selling Price:
Buying Price:
Entry in Member Box:
[-Candidate Purchase Offer Number:]
. . .
[Intermediary Transaction 2]
[-Sale Offer Number:]
. . .
[Intermediary Transaction 3]
[-Sale Offer Number:]
. . .

Further, each intermediary transaction record has additional fields, which are filled in when an candidate purchase offer which matches in transaction condition with that sale offer is found. The additional fields are for the candidate purchase offer number of the candidate purchase offer, the member box number of the candidate purchase offer, the determined selling price and the determined buying price. In another field, “Entry in Member Box”, whether or not necessary data has been entered by the server in corresponding member boxes is written (e.g. “not entered yet” or “entered”). When there are two or more candidate purchase offers, similar sets of such fields for the additional purchase offers are displayed and filled.

The inclusion of the “Last Purchase Offer Number Checked” in the last member box search can save time for searching the purchase offer records by preventing duplicate searching of the purchase offer records which have been already searched in the previous searching.

The server 21 can utilize the member box number of the member offering the sale and the sale offer number to look into the sale offer record in the member box of the seller. Also, the server 21 can utilize the candidate buyer member box number and the candidate purchase offer number to look into the purchase offer record in the member box of the candidate buyer.

No members can access the intermediary transaction file 104.

Commodity Category Master File

The commodity category master file 106 includes fields for commodity categories, commodity groups, and commission rates. The commission rate for the category of cellular phones may be, for example, 10%.

Member's History Database

The member's history database 107 contains the current valid data in the previously described member database 103, and includes fields for an old member box number, an old name, an old telephone number, an old address, an old electronic mail address, an old account number, a reason for previous withdrawal, a previously adopted commission rate, the date of last transaction, and a reason for present withdrawal for each member.

Complaint Database

The complaint database 108 includes data relating to complaining members, transaction data of the complaining members and complaint points relating to complaints from the complaining members. The complaint points can indicate credibility of the members in the past transactions. The point for a complaint relating to the payment may be, for example, ten (10) points, five (5) points for a complaint relating to a commodity, and three (3) points for a complaint relating to delay in delivery. The sum of these points is indicated.

Withdrawal Reason Master File

The withdrawal reason master file 109 includes fields for withdrawal reason codes and withdrawal reason contents.

Member's Buying and Selling History Database

The member's buying and selling history database 110 includes a field for a member box number for each member, and a buying and selling history of that member including an indication of purchase or sale, commodities sold and bought by that member, buying and selling prices of the commodities and a complaint flag indicating whether any complaints have been received from that member.

Server Processing Function

The server 21 has various intermediary functions including a member management function, a transaction function and a data management function (102 in FIG. 1).

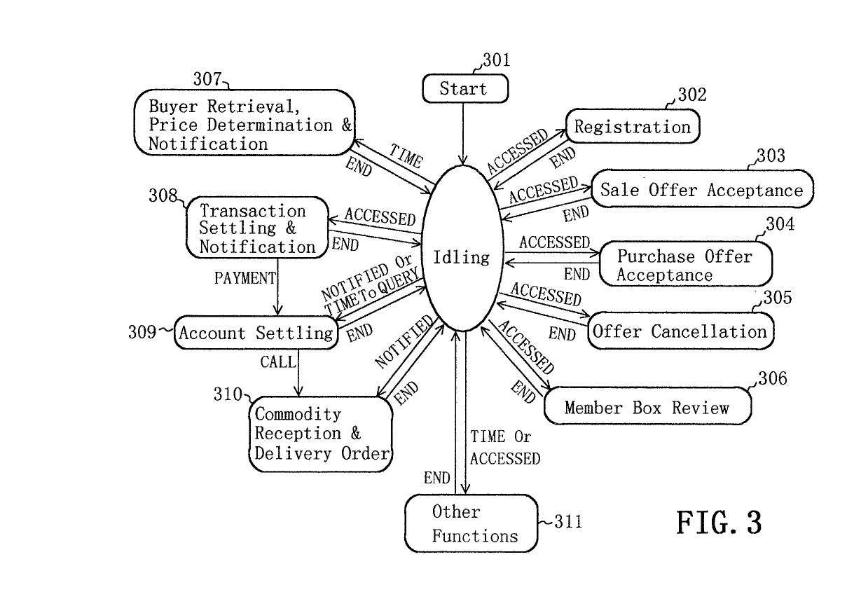

Now, referring to FIG. 3 which is a transition diagram of various functions 302-311 of the transaction intermediary server 21 executed by the processor 101 shown in FIG. 1, the member management function includes a member registration (302), correction and withdrawal function, a member rating function, a member deleting function, and a member's transaction history analysis function.

The transaction function includes a purchase and sale offer accepting and offer cancellation accepting function 303-305, a member box reviewing function 306, a buyer extracting, buying and selling price determining and purchase condition notifying function 307, a transaction settling and notifying function 308, an account settling function 309, a commodity receiving and delivery ordering function 310, and an informing function and a transaction time limit monitoring function. The functions other than the functions 302-310 are essentially those of the type represented by the functions 311.

The data management function includes a member database management function, a member's history database management function, a member buying and selling history database management function, a complaint database management function, a commodity category master file management function, a withdrawal reason master file management function, an intermediary transaction file management function, and a member box management function.

The server processor 101 executes these functions in response to accesses by members, external notifications, and calling through other functions, or sequentially or simultaneously at given timing.

Member Registration, Correction and Withdrawal Function

The member registration, correction and withdrawal function includes a member registration function 302, a member data correction function and a member withdrawal function (311).

Member Registration Function

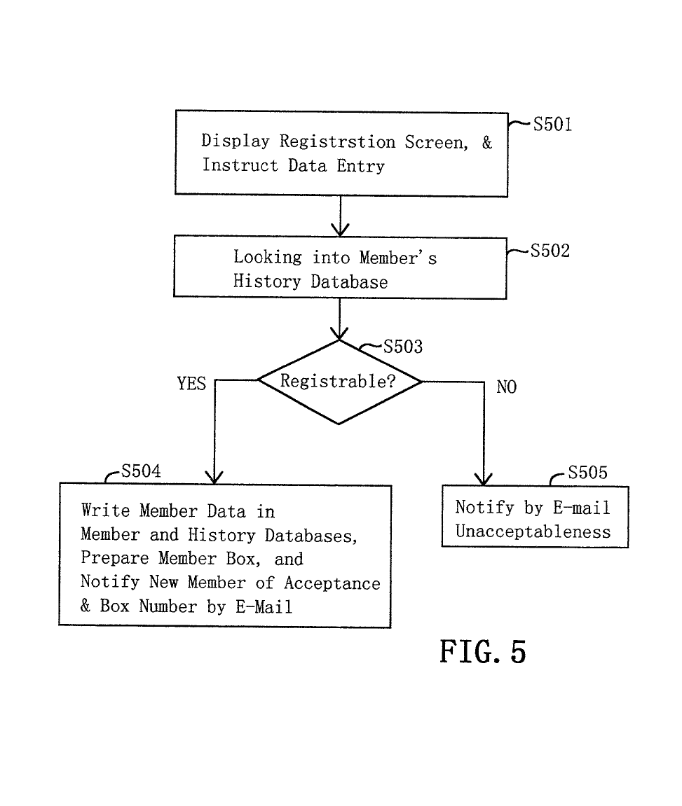

The member registration function 302 shown in FIG. 3 is a function for registering individuals intending to offer sale or purchase as members of the electronic commerce intermediary system in the server machine 21 through the client machines 121 and 122 shown in FIG. 1. In FIG. 5, a flow chart of the member registration function 302 is shown.

When the server 21 is accessed by an individual client machine in the step 1 shown in FIG. 2 and the member registration function is selected through a Transaction Intermediary Processing Menu screen 400 shown in FIG. 4, used as a display screen for function selection, by clicking an item No. 11 “Member Registration”, the server 21 causes the member registration screen to be displayed in Step 501 in the flow chart of FIG. 5, and give instructions to the individual who intend to register himself or herself as a member to enter the data necessary for the registration in the respective fields, namely, the name, the password, the address, the telephone number, the electronic mail address and the bank account number of the individual. In Step 502, the server 21, in response to the entered data, looks into the member's history database 107 and the complaint database 108, and judges in Step 503 whether or not the individual can be accepted as a member, i.e. whether or not any complaints had been received from him or her if he was once a member and, if received, whether or not the complaint point is below a predetermined reference point. If the complaint point is above the reference point, the server 21 rejects his or her registration as a member and notifies, by electronic mail, the individual that the system cannot accept him or her as a member, in Step 505. If the individual is acceptable as a member, the server 21, in Step 504, writes the data entered for registration in the member database 103 and the member's history database 107, and prepare his or her member box 105 with a box number assigned to it. Then, the server 21 notifies the new accepted member of the acceptance and of his or her member box number by electronic mail.

Member Data Correction Function

The member data correction function (311) is a function by which members can correct their member data. When the server 21 is accessed by a member client machine, and the function, Item No. 12 in the display screen shown in FIG. 4 is selected, and the member box number field and the password field are filled, the server 21 looks into the member database to determine whether the member who has accessed the server is a member or not. If he or she is a member, the server 21 causes a member data correction screen containing the member data of the member to be displayed and instructs the member to fill the correct data fields with corrected data. The server 21, in response to the data entry, causes a corrected screen to be displayed and instructs the member to confirm the corrected data. The member database is then corrected according to the corrected data, and the corrected data is added to the member's history database.

Withdrawal Function

The withdrawal function (311) is a function by which a member can leave from the intermediary system. The member who intends to leave the system accesses the server 21 through a client machine, selects the withdrawal function on the function selection screen 400 shown in FIG. 4, and enters his or her member box number and password. Then, the server 21 looks into the member database to confirm his or her membership. If the membership is confirmed, the server 21 causes a member withdrawal screen to be displayed to show currently valid member data and instructs the member to enter withdrawal data. The member is also instructed to enter the reason for the withdrawal, for analysis of withdrawal reasons to be made later. In response to the data entry, the server notifies the member of the acceptance of his or her withdrawal on the display screen, delete the member data in the member database, and stores it in the member history database as old member data.

Member Rating Function

The member rating function (311) is a function for rating or evaluating members according to their contribution to the intermediary system, i.e. according to the amounts of their transactions and the number of transactions. A commission rate or discount rate for each of the members is determined on the basis of his or her rating in the system. The commission factor is the largest, i.e. one (1), for new members in their initial membership period. The server 21 periodically re-rates each member according to, for example, the sum of the amounts of transactions, (the sum of the amounts of transactions)÷the membership period (i.e. the time period for which the member has been a member), the number of transactions the member has made, (the number of transactions)÷the membership period, or (the sum of the amounts of transactions)÷(the number of transactions)÷the membership period, and then, based on this rating, determines the commission factor for each member. Then, the old commission factor in the member database is renewed to, for example, 0.9.

Member Deletion Function

The member deleting function (311) is a function to delete members with their consent in principle. The members to be deleted are those who have not made transactions for a long time. The server 21 periodically looks into the member database and extracts those members who have not made transactions long time, and notifies them that they will be removed from the list of the members of the system by electronic mail. The server 21, then, deletes the member data in the member database of the members who were notified of their removal from the system but have not taken any action to it for a predetermined period or who agreed to remove their names from the system, and stores the deleted member data in the member history database.

Member Transaction History Analysis Function

The member's transaction history analysis function is a function to store the transaction history of each member in the member transaction history database and manage it. With this function, a person who is managing the transaction intermediary system can analyze the trend in sale and purchase of each member and use the analysis in his business strategy. The managing person can look into the member transaction history database to make analysis of categories and numbers of commodities offered for sale for each member, categories and numbers of commodities offered for purchase for each member, ranks in number of sold commodities, commodities not sold, and the like. Based on such analysis, the server 21 can prepare and present forum information in the member boxes 105 or send such information by electronic mail, determines or modifies the presentation order of the commodity categories. For example, commodities of the categories sold more are presented first.

The purchase and sale offer accepting and offer cancellation accepting function includes a sale offer accepting function 303, a purchase offer accepting function 304 and a purchase and sale offer cancellation accepting function 305. These functions are described now.

Sale Offer Accepting Function

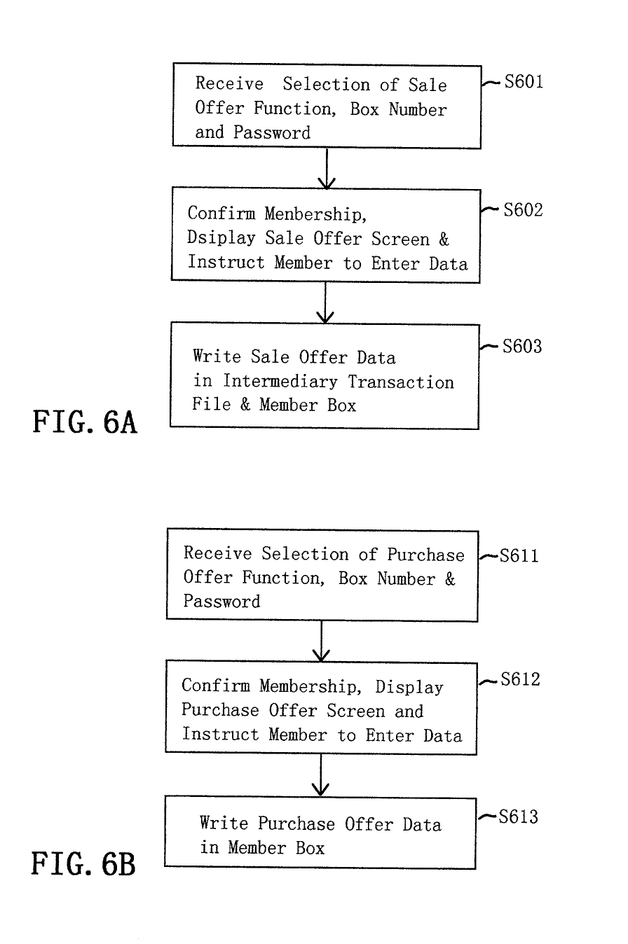

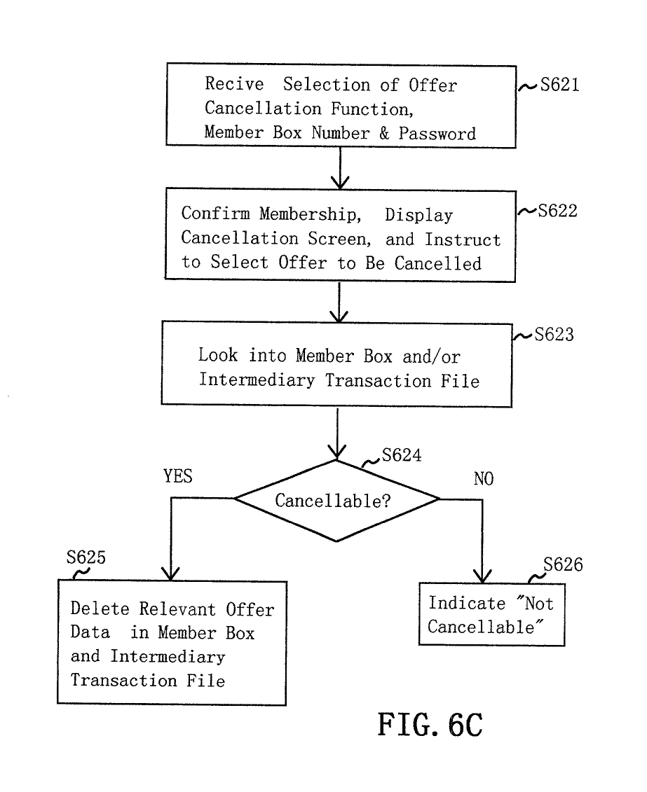

The sale offer accepting function 303 is a function for receiving and accepting a sale offer from a member. FIG. 6A is a flow chart for the sale offer accepting function 303. When the server 21 is accessed by a member client machine, the transaction intermediary processing menu 400 shown in FIG. 4 is displayed in Step 601 in FIG. 6A. The member is then selects this function 31 on the display screen 400 and enters his or her member box number and password. When the server 21 receives the member box number and password data, it looks into the member database in Step 602 to see whether there is any data corresponding to the entered data. If he or her membership is confirmed, the server 21 causes a sale offer acceptance screen (not shown) to be displayed and instructs the member to fill the respective fields for the commodity category, the commodity name, the transaction time limit, the lowest allowable selling price SPmin, and the commodity information, such as the age and model of the commodity, its digital photograph, and the like. The digital photograph may be image data of the commodity offered for sale taken by a digital camera. Next, in Step 603, the server 21 responds to the data entry through the sale offer acceptance screen, for extracting required data from the entered data, assigns a sale offer number, forms an intermediary transaction record and stores it in the intermediary transaction file 104. The server 21 also prepares a sale offer record and stores in the member box 105 of that member. If the member box number or password entered on the transaction intermediary processing menu 400 is wrong, an indication “Invalid” is displayed in the member box number field.

Purchase Offer Accepting Function

The purchase offer accepting function 304 is a function for receiving and accepting a purchase offer from a member. FIG. 6B is a flow chart of the purchase offer accepting function. A person can access the server 21 via a client machine, select the function No. 32 on the menu screen 400 shown in FIG. 4 in Step 611, and enters his or her member box number and password. The server 21, upon receipt of the data, namely, the member box number and password, looks into the member database to the validity of the member box number and password. If his or her membership is confirmed, the server 21 causes a purchase offer acceptance screen (not shown) to be displayed on the client machine, and instructs the member to enter, through the purchase offer acceptance screen, the category of the commodity he or she wants to purchase, the transaction time limit, and the highest allowable buying price BPmax. In Step 613, the server 21 responds to the data input by assigning a purchase offer number to the data and prepare a purchase offer record, which is then stored in the associated member box 105. Consecutive offer numbers are given to sale and purchase offers in common, but separate consecutive number may be assigned to sale and purchase offers.

Purchase and Sale Offer Cancellation Accepting Function

The purchase and sale offer cancellation accepting function 305 is for accepting cancellation purchase and/or sale offers by a member. The cancellation can be accepted before a candidate buyer decides to buy a candidate commodity and the transaction is settled. FIG. 6C is a flow chart of the purchase and sale offer cancellation accepting function. A person who wants to cancel a particular offer accesses the server 21 through a member client machine so that the menu 400 (FIG. 4) can be displayed, selects the purchase and sale offer cancellation accepting function No. 33 on the menu 400, and then is instructed by the server 21 to enter his or her member box number and password, in Step 621. In Step 622, the sever 622 checks the person with the member database to determine whether he or she is actually a member and, if his or her membership is confirmed, looks into the member box 105, causes a currently stored sale and purchase offer record as well as a purchase and sale offer cancellation acceptance screen (not shown) to be displayed on the client machine, and instructs the member to select the sale or purchase offer number to be cancelled and to click the “Execution” button.

In Step 623, the server 21 responds to the selection of the offer to be cancelled and the execution of cancellation, and, in Step 624, makes a judgment as to whether the offer can be cancelled or not, seeing the sale status in the intermediary or sale offer record or the purchase status in the purchase offer record. An offer can be cancelled before the relevant sale status or purchase status indicates the settlement of the transaction or purchase and sale. If the offer is no longer cancelable, an indication “Not Cancelable” is displayed on the cancellation acceptance screen.

If the offer is cancelable and if it is a sale offer, the server in Step 625 deletes the relevant sale offer record and the intermediary transaction. In addition, if the sale status indicates that “There Is a Candidate Buyer”, relevant candidate sale offer data is deleted from the purchase offer record in the candidate buyer's member box corresponding to the candidate purchase offer number in the intermediary transaction record. If there is no sale offer data in the purchase offer record of that candidate buyer's member box, the server 21 has to change the purchase status in the purchase offer record to “No Seller”.

If the cancelable offer is a purchase offer, the purchase offer record in the relevant member box is deleted, and if the purchase status is “Candidate Buyer”, the relevant purchase offer data is deleted from the intermediary transaction file for the candidate purchase offer number in the purchase offer record. If this deletion results in no candidate purchase offer data in the corresponding intermediary transaction record, the server 21 has to change the sale status in each of the intermediary transaction file and the corresponding sale offer record to “No Buyer”.

When a sale offer is cancelled, the sale offer data in the associated sale offer record and in the purchase offer record containing the number of the sale offer are deleted, and when a purchase offer is cancelled, the purchase offer data in the corresponding purchase offer record is deleted. Instead of deleting the data, an indication “Deleted” may be placed after the offer numbers of the offers deleted.

Member Box Reviewing Function

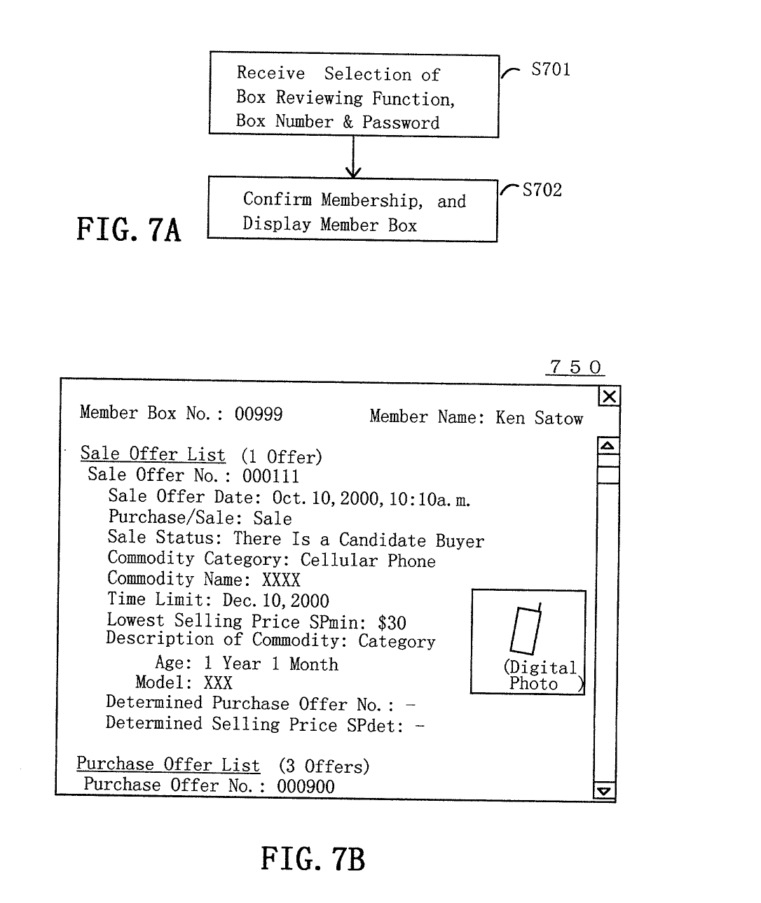

The member box reviewing function 306 is a function for informing a member accessing the server 21 of his or her current active purchase and sale offers in his or her member box 105 by displaying them on the client machine. FIG. 7A is a flow chart for the function 306. The member accesses the server 21 through his client machine. Then, the function selection menu 400 shown in FIG. 4 is displayed, and the member selects the member box reviewing function (No. 2) in the menu and enters the member box number and password, which are received by the server 21 (Step 701). In response to the member box number and the password, the server 21 confirms his or her membership by referring to the member database in Step 702. If the membership is confirmed, a member box reviewing screen 750 like the one shown, for example, in FIG. 7B is displayed on the client machine. The member box reviewing screen 750 includes sale and purchase offer lists (previously described TABLE I-1 and TABLE I-2) in the member box 105 of the member who accessed the server 21.

Buyer Extracting, Buying and Selling Price Determining and Notifying Function

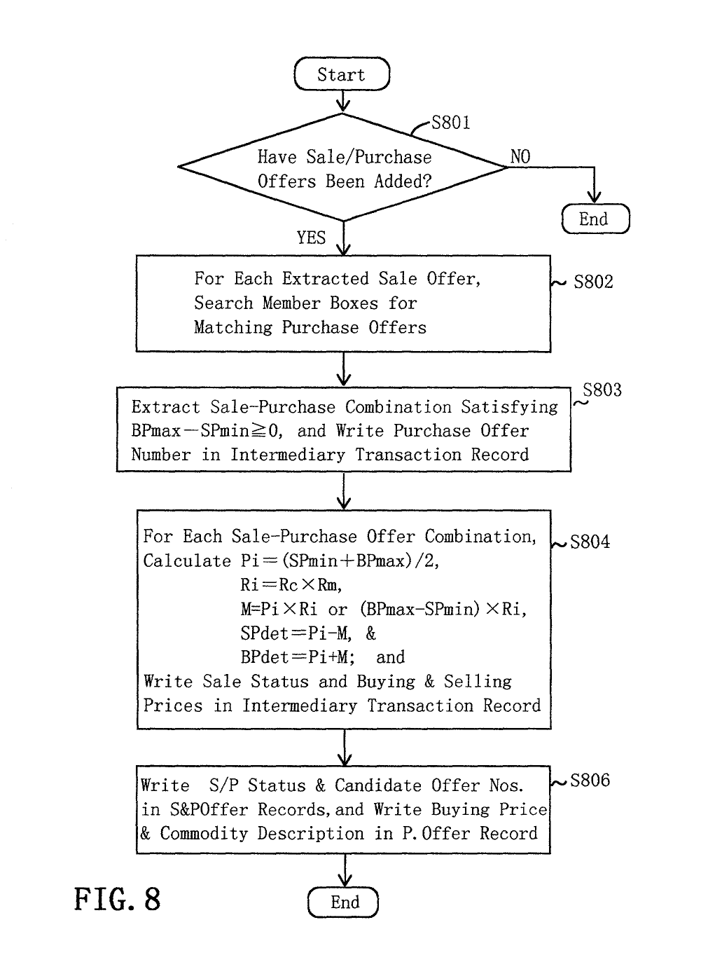

The buyer extracting, buying and selling price determining, and notifying function 307 includes a buyer extracting function, a buying and selling price determining function and a purchase condition notifying function. FIG. 8 is a flow chart of the buyer extracting, the buying and selling price determining and the purchase condition notifying functions which are periodically executed by the server 21. These functions are described below.

Buyer Extracting Function

The buyer extracting function includes Steps 801-803 shown in FIG. 8. For each of the sale offer numbers of the unsettled sale offers in the intermediary transaction records in the intermediary transaction file 104, the server 21 searches purchase offer records in the member boxes for extracting candidate purchase offer records containing transaction conditions matching those of the unsettled sale offers. When the buyer extracting function is to be activated (at intervals of, for example, five minutes), the server 21 makes a judgment in Step 801 as to whether or not one or more sale or purchase offers have been accepted since the last search or whether or not one or more sale or purchase offer numbers have been added since the last search. If no additional sale or purchase offers have been found, the server 21 ends this processing and await the next time for the search.

If one or more sale or purchase offers have been added, the server 21 in Step 802 retrieves intermediary transaction records with the sale status indicated as being unsettled, for each commodity category, successively from a smallest offer number. It should be noted that the first field appearing in each sale-offer-based intermediary transaction record is for a sale offer number. The server 21, referring to the commodity category of the sale offer record in the member box 105 corresponding to the sale offer number in the intermediary transaction record, searches sequentially purchase offer records in other member boxes in the order of the offer numbers to extract the records of respective purchase offers matching the subject sale offer in commodity category. In this case, it is sufficient to search purchase offer records assigned with purchase offer numbers newer than the “Last Purchase Offer Number Checked” in the intermediary transaction record. All of possible purchase offers for the same commodity category of each sale offer are sequentially retrieved or extracted. In this way, all combinations or pairs of sale and purchase offers for the same commodity categories are extracted.

Alternatively, each time a sale or purchase offer record is added, the corresponding member box number is added to the offer number, and the offer number is entered into a queue. When one or more offer numbers are in the queue, they are taken out one by one. The server 21, seeing the sale or purchase offer record in the member box 105 for each offer number taken out from the queue, searches the unsettled purchase of sale offer records in the member boxes in a sequential order to retrieve purchase or sale offer records containing the same commodity record as the offer number taken out from the queue. In this case, only those unsettled purchase or sale offer records having offer numbers older than the offer number taken out from the queue are searched.

Next, in Step 803, the server 21 make a judgment as to whether the lowest allowable selling price SPmin and the highest allowable buying price BPmax of each sale and purchase offer combination fulfill the condition expressed by the following expression.

Bpmax−SPmin≧0 (1)

Any combinations which do not fulfill this relationship are excluded and not extracted. The sale offer number and the purchase offer numbers in the combinations fulfilling this relationship are temporarily stored in a memory working area for subsequent processing. Alternatively, the purchase offer number may be written in the intermediary transaction record in which the sale offer number is stored.

Buying and Selling Price Determining Function

The buying and selling price determining is done in Step 804 to determine the selling price and the buying price for the combination fulfilling the relationship expressed by the expression (1) extracted in Step 803. In Step 804, the server 21 first calculates the intermediary price Pi for the combination in accordance with the following equation (2).

Pi=(SPmin+BPmax)÷2 (2)

Next, the server 21 calculates the commission rate Ri for the particular combination, using the commission rate Rc for each commodity category in the commodity category master file 106 and also the commission factor (discount rate) Rm(≦1) for each member in the member database.

Ri=Rc×Rm (3)

Then, the intermediary margin (M) is calculated either of the following equations (4) and (5). The intermediary margin may include a profit, an expense, a tax and the like. Furthermore, for a more reasonable value of M, either one of the two values M calculated by the two equations may be employed.

M=Pi×Ri (4)

M=(Bpmax−SPmin)×Ri (5)

Then, the selling price SPdet to be presented to the seller and the buying price BPdet to be presented to the buyer are determined by the following equations (6).

SPdet=Pi−M

BPdet=Pi+M (6)

If the intermediary margin M according to the equation (5) is adopted, it is desirable to use a generally larger Rc than the one used for the equation (4). When BPmax=SPmin, the intermediary margin M is zero (0). However, with Rc≦0.5, it is advantageously that the selling price SPdet is equal to or higher than the lowest allowable selling price SPmin (i.e. SPdet≧SPmin), and the determined buying price BPdet is equal to or lower than the highest allowable buying price BPmax (i.e. BPdet≦BPmax).

Then, the server 21 writes in the field for the sale status in the associated intermediary transaction record in the transaction file 104, an indication “There Is a Candidate Buyer”. Also, the server 21 writes in the transaction record, the corresponding purchase offer number, the member box number of the candidate buyer, the determined selling price SPdet, the determined buying price BPdet, and the indication “not entered yet” in the “Entry in Member Boxes” field for subsequent processing. It should be noted that if the purchase offer number has been already written in the intermediary transaction record, no additional entry is required. For one intermediary transaction record, a plurality of candidate purchase offers and corresponding sets of selling and buying prices may be written.

The server 21 writes a candidate sale offer number and a determined buying price BPdet in the corresponding purchase record in the member box. Unless the transaction with respect to the sale offer in the transaction record is settled, a plurality of additional candidate purchase offers may be added to the sale offer in the intermediary transaction file 104.

Purchase Condition Notifying Function

The purchase condition notifying is done in Step 806. By this function, a sale status of his or her sale offer is notified to the seller member, and a purchase status of his or her purchase offer of the buyer member, the determined buying price BPdet for the extracted candidate sale offer and the description of the offered commodity are notified to the candidate buyer. In Step 806, the server 21 searches for the purchase offer number of a candidate newly written in or added to the intermediary transaction record, i.e. the candidate whose member box includes an indication of “not entered yet” in its “Entry in Member Boxes” field, and writes “There Is a Candidate Buyer” in the sale status field of the correponding sale offer record in the member box 105 of the seller. If the indication of “There Is a Candidate Buyer” has been already in the sale status field, there is no need for changing the entry. At the same time, the server 21 writes “Candidate Buyer” in the purchase status field of the purchase offer record in the member box of the candidate buyer corresponding to the candidate purchase offer number. Also, the sale offer number, the determined buying price BPdet, and the description of the commodity for sale are written in. Further, “Purchase Undecided” is written in the purchase settlement status field. If the “Candidate Buyer” has been already written in the purchase status field, no entry for the purchase status is necessary. After filling in the member box, the Entry in Member Box field is filled with an indication of “Entered”. Alternatively, instead of using the Entry in Member Box field in the intermediary transaction record for writing relevant data in the member boxes, the data may be written simultaneously with or subsequent to the writing of the sale status, the selling and buying prices and the like in the intermediary transaction record following the calculation of the selling and buying prices.

Thus, a plurality of buying prices and commodity descriptions for a plurality of candidate sale offers can be written in one purchase offer record in the member box 105. Also, before transaction has been settled for each sale offer, data of more than one additional candidate sale offers may be added to one purchase offer record in the member box. The server 21 notifies the buyer member of the purchase status by writing in the member box. Each member can see the current data of his or her offers by reviewing his or her member box. The server 21 may notify the buyer member by electronic mail that a candidate sale offer has been found.

Transaction Settling and Notifying Function

The transaction settling and notifying function 308 is a function to decide a candidate buyer who has been notified of the determined purchase conditions (i.e. the price and commodity information) as the buyer of a commodity in response to the candidate buyer's decision to buy the commodity, to thereby settle the transaction, write the settling of the transaction in the status fields in the intermediary transaction record, the sale offer record and the purchase offer record, delete other candidate purchase offer data from the intermediary transaction record, and notify the settlement of the transaction to the buyer and the seller.

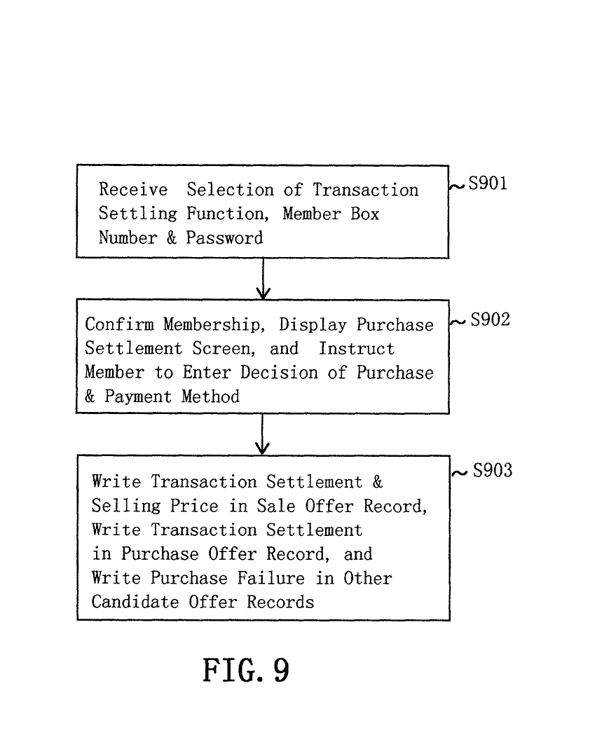

FIG. 9 is a flow chart of the transaction settling and notifying function. In response to the access to the server 21 by a buyer member, the Processing Menu screen 400 shown in FIG. 4 is displayed on the client machine, and the member selects the function No. 4 through the screen 400 and enters his or her member box number and password. In response to the entry of the member box number and password in Step 901, the server 21 confirms the buyer's membership in Step 902 and displays a purchase settlement screen (not shown) on the client machine, instructing the buyer member to enter the decision of purchasing and the selection of a payment method through the display screen 400. In the purchase settlement screen, the purchase offer list (see TABLE I) in the member box of the buyer member is also displayed. Seeing the purchase status (“Candidate Buyer”) of the purchase offer and the buying price of the extracted one candidate sale offer in the list, the buyer enters “Purchase Decided” and selects one of the payment into bank account and the payment by credit card. For the credit card payment, when the buyer enters his or her credit card number through the purchase settlement screen, the server 21 accesses the clearing house 128 (FIG. 1) to find if the credit card is valid. If it is valid, the server 21 processes the payment procedure, i.e. demands payment of a credit service company. For the payment into bank account, the buyer may pay, through the purchase settlement screen, the price from his or her bank account into the bank account the intermediary specifies, or may pay into the intermediary's bank account in an ordinary manner.

In Step 903, in response to the decision made by the buyer to buy the commodity, the server 21 looks into the corresponding intermediary transaction record for the sale status. If an indication “There Is a Candidate Buyer” is in the sale status field, the server provides the following processing. The server 21 writes “Transaction Settled” in the sale status in the corresponding intermediary transaction record and also in the sale status field in the corresponding sale offer record of the seller member box. Further, the server 21 writes in the determined selling price in the “Determined Selling Price” field. Thus the settling of the transaction is notified to the seller. Also, the server 21 writes “Transaction Settled” in the purchase status field in the purchase offer record of the corresponding buyer member box, to thereby notify the buyer of the settling of the transaction. In addition, the server 21 deletes the selling and buying prices in other candidate purchase offers in the intermediary transaction record. The seller can access the sale offer record in his or her member box in which the selling price is stored, through the member box reviewing function. In addition, the server 21 may notify the seller of the settling of the transaction by electronic mail. Using the member box reviewing function, the buyer member can access the purchase offer record in his or member box in which his or her decision to buy, i.e. the settling of the transaction, and the determined buying price are stored.

Further, if the candidate purchase offer numbers in the intermediary transaction record of the commodity include other purchase offer numbers from which the prices have been deleted, the server 21, in Step 903, retrieves the corresponding purchase offer records in the member boxes of the other candidate buyers, and deletes data relating to the sale offer in such records. If there is no other candidate sale offer data shown in the purchase offer record in each of the other candidate buyer member boxes, the server 21 fills the purchase status field with “No Seller/Purchase Failed”, to thereby notify that candidate buyer that he or she has failed to buy the commodity. If, on the other hand, there is any other candidate sale offer data in the purchase offer status, the indication of “Candidate Buyer” is changed to “Candidate Buyer/Purchase Failed”. Alternatively, this fact may be notified to that candidate buyer by electronic mail.

The data in the fields of the candidate sale offers in each purchase offer record in the member box of a candidate buyer, who failed to buy the commodity, may be held unchanged until the candidate buyer next reviews the member box, while the field for the purchase status is filled with “Purchase Failed”.

Before he or she finally decides the purchase of a commodity of the extracted candidate sale to thereby finally settle the transaction, a candidate buyer can select any one of a plurality of candidate sale offers which have been or will be written in his or her purchase offer record, or can await a more favorable candidate sale offer (commodity). In such a case, however, there is a possibility that one or more candidate sale offer (and, hence, commodities) may be sold out.

Account Settlement Function

The account settlement function 309 is a function by which the server 21 obtains confirmation of the payment by the buyer into the bank account of the manager of the server 21, calls the function 310 for instructing the deliverer 24 to receive the commodity from the seller and to deliver it to the buyer, and pays the selling price into the bank account of the seller.

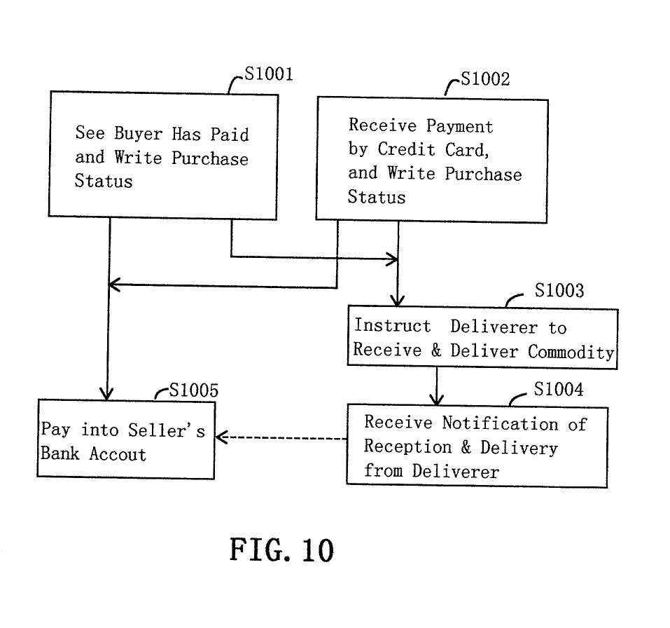

If the buyer has selected the payment into the bank account in Step 902 in FIG. 9, the server 21 sees whether or not the money has been paid into the intermediary's bank account by accessing the payment adviser 125 (FIG. 1) or by receiving payment advice by electronic mail from the payment adviser 125, in Step 1001 shown in FIG. 10. If the payment has been made, the server 21 fills the purchase status field in the purchase offer record in the buyer's member box 105, with “Paid”.

If the buyer has selected the payment by credit card in Step 902, the server 21 accesses the clearing house 128 (FIG. 1) to see whether the buyer's credit card is valid or not in Step 1002. If the card is valid, the server 21 settles and fills the purchase status field with “Paid” in the purchase offer record in the buyer's member box 105.

Following Step 1001 or 1002, the account settlement function 309 branches to Step 1003 in which the commodity receiving and delivery ordering function is achieved. Subsequent to Step 1003, the server 21 pays the selling price from the intermediary's bank account into the bank account of the seller. The server 21 may make this payment only after it has received from the deliverer 130 (FIG. 1) a notification of the deliverer's receiving the commodity from the seller in a given format.

Commodity Receiving and Delivery Ordering Function

The commodity receiving and delivery ordering function 310 is a function called in the account settlement function 309. By this function, the server 21 instructs the deliverer 130 (FIG. 1) to receive the commodity from the seller and to deliver it to the buyer. Seeing that the buyer has made payment, the server 21 instructs the deliverer 130 to receive the sold commodity from the seller and to deliver it to the buyer by sending the deliverer 130 electronic mail in Step 1003 in FIG. 10. After receiving the commodity from the seller, the deliverer 130 sends electronic mail to the server 21 to notify it of the reception of the commodity, and, after the delivery of the commodity, sends electronic mail to the server 21 to notify it of the delivery of the commodity to the buyer. Receiving the notification from the deliverer 130, the server 21, in Step 1004, fills the sale status fields in the intermediary transaction record and the sale offer record with words, “Commodity Received”, and fills the purchase status field in the corresponding purchase offer record with words, “Commodity Delivered”.

Informing Function

The informing function (311) is a function by which the server 21 gives members information about commodities which have not been sold yet. Lists of such commodities sorted into respective commodity categories are arranged to be displayed on client machines together with their descriptions. However, no price data is displayed. When a member accesses the server 21 for display of the menu screen 400 (FIG. 4), selects this function (No. 5) and enters his or her member box number and password through the display screen 400, the server 21 causes an information screen (not shown) on the client machine and instructs the member to select or enter the category of commodities he or she is interested in. When the commodity category is entered, the server 21 retrieves and displays names and descriptions of commodities of the category in interest from the sale offer lists in the member boxes 105.

Transaction Time Limit Monitoring Function

The transaction time limit monitoring function (311) is a function for managing time limits by which a sale offer or purchase offer must be settled. If a transaction involving a sale offer or purchase offer is not settled in a assigned time limit, the server 21 treats such offer as an unsettled transaction and processes it as follows. The server 21 periodically looks into the member boxes 105 for offer dates and transaction time limits, and deletes sale and purchase records in the member boxes and the corresponding transaction records in the intermediary transaction file 104, for those sale and purchase offers the transaction time limits have been already come. Offers for which no time limits have been indicated are also deleted when a predetermine time period has passed. Then, the server 21 notifies such deletion to those members whose offers have been deleted, by electronic mail.

Commodity Category Master File Management Function

The commodity category master file management function is a function for managing the commodity category master file 106 (FIG. 1). The server manager accesses the server 21 to record, correct or delete commodity categories, using the member's buying and selling history analyzing function, sorts the respective commodity categories and determines the commission rate for the rated commodity categories.

Member Database Management Function

The member database management function is a function called each time a member accesses it or in response to the periodically activated member registration, correction and withdrawal function and also in response to the periodically activated member deleting function, for writing, correcting and deleting data in the member database 103.

Intermediary Transaction File Management Function

The intermediary transaction file management function is a function called by accessing through a client machine or by periodical activation of the functions 303, 305, 307, 308, 309 and 310, for writing, correcting and deleting data in the intermediary transaction file 104. The server 21 periodically sees if any sale status fields are filled with “Paid/Commodity Received”, and, if they are, deletes the corresponding intermediary transaction records in the intermediary transaction file 104.

Member Box Management Function

The member box management function is a function called in response to accessing through a client machine or in response to periodical activation of the functions 303, 304, 305, 307, 308, 309 and 310, for writing, correcting and deleting data in the member boxes 105. The server 21 periodically sees if any sale or purchase status fields in sale and purchase offer records are filled with “Paid/Commodity Received” or “Paid/Commodity Delivered”, and, if they are, deletes those sale or purchase offer records.

Member's History Database Management Function

The member's history database management function is used when a member accesses and selects this function or when data is periodically written, corrected or deleted in and from the member database 103, to write, correct or delete data in the member's history database 107.

Member's Buying and Selling History Management Function

This function is called periodically by the activation of the function 308, for writing, correcting and deleting data in the member's buying and selling history database 110.

Withdrawal Reason Master File Management Function

This function is called by a member for writing, correcting and deleting data in the withdrawal reason master file 109.

Complaint Database Management Function

The complaint database management function is accessed by the intermediary system manager for writing, correcting and deleting data in the complaint database 108 in accordance with member's complaints sent by electronic mail.

The present invention has been described by a typical example. People skilled in the art can easily modify it within the scope of the attached claims.

What is claimed is:

1. A transaction intermediary apparatus comprising:
a memory;
record writing means for writing a record of a sale offer into said memory in response to entry by a potential seller through an information processing device and for writing a record of a purchase offer into said memory in response to entry by a potential buyer through an information processing device, said sale offer record including information descriptive of a commodity for sale the seller offers and a lowest allowable selling price of said commodity for sale set by the seller, said purchase offer record including information descriptive of a desired commodity the buyer wants to buy and a highest allowable buying price of said desired commodity set by the buyer; and
extracting means for searching said memory with a plurality of sale and purchase offer records stored therein for extracting records of sale and purchase offers which match in conditions relating to the commodities and prices, and determining a selling price to be presented to the seller and a buying price to be presented to the buyer of the commodity in the extracted sale offer record, from the lowest allowable selling price in the extracted sale offer record and the highest allowable buying price in the extracted purchase offer record, said determined selling price being not higher than said determined buying price;
said extracting means writing the commodity descriptive information of said extracted sale offer record and said determined buying price, into said extracted purchase offer record in said memory.

2. The apparatus according to claim 1 wherein said record writing means further writes an intermediation record into said memory, said intermediation record correlating said extracted matching sale and purchase offer records.

3. The apparatus according to claim 1 wherein the selling price is determined in accordance with a category of the commodity for sale and/or a buying and selling history of the seller, and said buying price is determined in accordance with a category of the commodity for sale and/or a buying and selling history of the buyer.

4. The apparatus according to claim 1 wherein the buyer and the seller are first required to be registered as a member with said apparatus, and said apparatus further comprises registering means for determining whether to permit an applicant to be a member based on information about a member history of the applicant if the applicant was once a member.

5. The apparatus according to claim 1 further comprising:
means responsive to a buyer's request made through an information processing device for providing a content of the purchase offer record of the buyer to the information processing device, and responsive to a seller's request made through an information processing device for providing a content of the sale offer record of the seller to the information processing device; and
means responsive to decision to buy the commodity for sale described in the extracted purchase offer record for writing the determined selling price of the commodity into the extracted sale offer record.

6. The apparatus according to claim 1 further comprising means responsive to payment for the commodity to be bought for instructing a deliverer to receive and deliver the commodity.

7. A transaction intermediary apparatus comprising:
a memory;
means for writing a record of a sale offer into said memory in response to entry by a potential seller through an information processing device and writing a sale status into the sale offer record, said sale offer record including information descriptive of a commodity for sale the seller offers and a lowest allowable selling price of said commodity for sale set by the seller, said writing means writing a record of a purchase offer into said memory in response to entry by a potential buyer through an information processing device and writing a purchase status into said purchase offer record, said purchase offer record including information descriptive of a desired commodity the buyer wants to buy and a highest allowable buying price of said desired commodity set by the buyer; and
extracting means for searching said memory with a plurality of sale and purchase offer records stored therein for extracting records of sale and purchase offers which match in conditions relating to the commodities and prices, and determining a selling price to be presented to the seller and a buying price to be presented to the buyer of the commodity in the extracted sale offer record, from the lowest allowable selling price in the extracted sale offer record and the highest allowable buying price in the extracted purchase offer record, said determined selling price being not higher than said determined buying price;
said extracting means writing the commodity descriptive information of said extracted sale offer record and the determined buying price, into the extracted purchase offer record in said memory, and modifying the purchase status of the extracted purchase offer record;
said apparatus further comprising answering means responsive to a buyer's request made through an information processing device for providing a content of the purchase offer record of the buyer to the information processing device.

8. The apparatus according to claim 7 further comprising:
processing means responsive to decision to buy the commodity for sale described in the extracted purchase offer record for modifying the purchase status in the extracted purchase record, writing the determined selling price of the commodity into the extracted sale offer record, and modifying the sale status in the extracted sale offer record;
said answering means being responsive to a seller's request through an information processing device for providing a content of the sale offer record of the seller to the information processing device.

9. The apparatus according to claim 7 or 8 wherein:
said extracting means searches the remainder of said plurality of purchase offer records stored in said memory for extracting another record of a purchase offer matching the sale offer of said extracted sale offer record in conditions relating to the commodities and prices, and determining another selling price and another buying price of the commodity in the extracted sale offer record, from the lowest allowable selling price in the extracted sale offer record and another highest allowable buying price in the extracted another purchase offer record, said determined another selling price is not higher than said determined another buying price; and
said extracting means further writes the commodity descriptive information of the extracted sale offer record and the determined another buying price of the commodity into the extracted another purchase offer record in said memory, and modifies the purchase status in the extracted another purchase offer record.

10. A transaction intermediary apparatus for mediating between a potential buyer and a potential seller, comprising:
a memory including a memory region externally accessible to said buyer and said seller, and a memory region externally inaccessible to said buyer and seller;
acceptor means responsive to entry to said apparatus by said seller for writing into said externally accessible memory region, a sale offer including a description of a commodity for sale offered by said seller and a lowest allowable selling price set by the seller, and responsive to entry to said apparatus by said buyer for writing into said externally accessible memory region, a purchase offer including a description of a commodity the seller wants to buy and a higher allowable buying price set by the buyer; and
extractor means for searching sale and purchase offers stored in said memory for extracting candidate sale and purchase offers matching in conditions relating to commodities and prices, and determining selling and buying prices of the commodity for sale in the candidate sale offer to be presented to the seller and the buyer, respectively, based on the lowest allowable selling price in the candidate sale offer and the highest allowable buying price in the candidate purchase offer, said determined selling price being not higher than said determined buying price;
said extractor means writing the commodity description of the candidate sale offer and the determined buying price, into the region of said memory where said candidate purchase offer is written.

11. The apparatus according to claim 10 wherein said acceptor means writes an intermediary record for relating the matching candidate sale and purchase offers with each other into said externally inaccessible memory region of said memory.

12. The apparatus according to claim 10 or 11 wherein said selling price is determine in accordance with a category of the commodity for sale and/or a buying and selling history of the seller, and said buying price is determined in accordance with a category of the commodity for sale and/or a buying and selling history of the buyer.

13. The apparatus according to one of claims 10, 11 and 12 wherein the buyer and the seller are first required to be registered as a member with said apparatus, and said apparatus further comprises registering means for determining whether to permit an applicant to be a member based on information about a member history of the applicant if the applicant was once a member.

14. The apparatus according to one of claims 10, 11, 12 and 13, further comprising:
means responsive to a buyer's request for providing a content of the purchase offer of the buyer, and responsive to a seller's request for providing a content of the sale offer of the seller; and
means responsive to decision to buy the commodity for sale in the extracted candidate purchase offer for writing the determined selling price of the commodity of the sale offer into the region of said memory where said candidate purchase offer is written.

15. The apparatus according to claim 14 further comprising means responsive to payment for the commodity to be bought for instructing a deliverer to receive and deliver the commodity.

16. The apparatus according to one of claims 10, 11, 12, 13, 14 and 15 wherein the description of the commodity comprises a digital photograph of the commodity.

17. A program stored in a recording medium for transaction intermediation for use in an information processing apparatus, said information processing apparatus including a memory and a processor, said program causing said processor to perform the steps of:
writing a record of a sale offer into said memory in response to entry by a potential seller, said sale offer record including information descriptive of a commodity for sale the seller offers and a lowest allowable selling price of said commodity for sale set by the seller;
writing a record of a purchase offer into said memory in response to entry by a potential buyer, said purchase offer record including information descriptive of a desired commodity the buyer wants to buy and a highest allowable buying price of said desired commodity set by the buyer;
searching said memory with a plurality of sale and purchase offer records stored therein for extracting records of sale and purchase offers which match in conditions relating to the commodities and prices;
determining a selling price to be presented to the seller and a buying price to be presented to the buyer of the commodity in the extracted sale offer record, based on the lowest allowable selling price in the extracted sale offer record and the highest allowable buying price in the extracted purchase offer record, said determined selling price being not higher than said determined buying price; and
writing the commodity descriptive information of the extracted sale offer record and the determined buying price, into the extracted purchase offer record in said memory.

18. The program according to claim 17 wherein said step of writing a record of a purchase offer includes writing an intermediary record for relating the extracted matching sale and purchase offer records with each other into said memory.

19. The program according to claim 17 wherein said program causes said processor to perform the further steps of:
providing a content of the purchase offer record of a potential buyer in response to the buyer's request;
providing a content of the sale offer record of a potential seller in response to the seller's request; and
writing the determined selling price of the commodity into the extracted sale offer record in response to decision to buy the commodity for sale described in the extracted purchase offer record.

20. The program according to claim 17 wherein said program causes said processor to perform the further step of instructing a deliverer to receive and deliver the commodity in response to payment for the commodity to be bought.

21. A program stored in a recording medium for transaction intermediation for an information processing apparatus, said apparatus including a memory and a processor, said program causing said processor to perform the steps of:
writing a record of a sale offer into said memory in response to entry by a potential seller and writing a sale status into the sale offer record, said sale offer record including information descriptive of a commodity for sale the seller offers and a lowest allowable selling price of said commodity for sale set by the seller;
writing a record of a purchase offer into said memory in response to entry by a potential buyer and writing a purchase status into said purchase offer record, said purchase offer record including information descriptive of a desired commodity the buyer wants to buy and a highest allowable buying price of said desired commodity set by the buyer;
searching said memory with a plurality of sale and purchase offer records stored therein for extracting records of sale and purchase offers which match in conditions relating to the commodities and prices;
determining a selling price to be presented to the seller and a buying price to be presented to the buyer, of the commodity in the extracted sale offer record, based on the lowest allowable selling price in the extracted sale offer record and the highest allowable buying price in the extracted purchase offer record, said determined selling price being not higher than said determined buying price;
writing the commodity descriptive information of said extracted sale offer record and the determined buying price, into the extracted purchase offer record in said memory, and modifying the purchase status of the extracted purchase offer record; and
providing a content of the purchase offer record of the buyer in response to a buyer's request.

22. The program according to claim 21 wherein said program causes said processor to perform the further steps of:
modifying the purchase status in the extracted purchase record in response to decision to buy the commodity for sale described in the extracted purchase offer record, writing the determined selling price of the commodity into the extracted sale offer record, and modifying the sale status in the extracted sale offer record; and
providing a content of the sale offer record of the seller in response to a seller's request.

23. The program according to claim 21 or 22 wherein:
said step of searching includes searching said memory for extracting another record of a purchase offer matching the sale offer of said extracted sale offer record in conditions relating to the commodities and prices; and
said step of determining includes determining another selling price and another buying price of the commodity in the extracted sale offer record, from the lowest allowable selling price in the extracted sale offer record and another highest allowable buying price in the extracted another purchase offer record, said determined another selling price being not higher than said determined another buying price; and
said step of writing the commodity descriptive information and determined buying price includes writing the commodity descriptive information of the extracted sale offer record and the determined another buying price, into the extracted another purchase offer record in said memory, and modifying the purchase status in the extracted another purchase offer record.

24. A price determining method in a transaction intermediation apparatus for receiving desired conditions for transactions from a potential buyer and a potential seller and mediating between the buyer and seller, comprising the steps of:
allowing the buyer and the seller to present ranges of allowable prices for commodities or services that the buyer and the seller are interested in;
retrieving a potential buyer and a potential seller presenting overlapping ranges of allowable prices;
determining a selling price and a buying price higher than the selling price, said selling and buying prices being within the overlap of said overlapping ranges of allowable prices; and
presenting said determined selling price to said retrieved seller and presenting said determined buying price to said retrieved buyer.
